(19) United States
(12) Patent Application Publication
(10) Pub. No.: US 2007/0006132 A1
(43) Pub. Date: Jan. 4, 2007

(54) Business process model unification method

(76) Inventors: Peter Weinstein, Saline, MI (US); Thomas Phelps, Brighton, MI (US); H. Van Dyke Parunak, Ann Arbor, MI (US)

Correspondence Address: John G. Posa;Gifford, Krass, Groh, Sprinkle,, Anderson & Citkowski, P.C., PO Box 7021, Troy, MI, 48007-7021, US

(21) Appl. No.: 11/430,108

(22) Filed: May 8, 2006

Related U.S. Application Data
(60) Provisional application No. 60/678,469, filed on May 6, 2005.

(51) Int. Cl. G06F 9/44

(52) U.S. Cl. 717/104

(57) ABSTRACT

A methodology for semi-automatic unification of models of business processes permits accurate comparison of business processes across government agencies or other organizations despite heterogeneity of language and style in the original models. Input into an algorithm includes a set of models produced by different organizations that describe roughly equivalent business processes (the original models). Output includes a single integrated model in which similarities are made explicit in shared generic layers of the model, while differences are represented in organization-specific layers that inherit from the generic layers (the unified model). Internally, the system represents the original and unified models in description logic using the Web Ontology Language (OWL).

### REFERENCE TO RELATED APPLICATION

This application claims priority from U.S. Provisional Patent Application Ser. No. 60/678,469, filed May 6, 2005, the entire content of which is incorporated herein by reference.

### FIELD OF THE INVENTION

This invention related generally to business process models and, in particular, to the semi-automatic unification of models of business processes.

### BACKGROUND OF THE INVENTION

Business process modeling has become an important tool for government planners as they work to improve their organizations. Unfortunately, in a cross-organizational context business process models often fail to deliver meaningful insights because models developed by different teams are hard to compare. Unfortunately, modelers use different terminology and styles and this hides genuine differences in the processes. Thus there exists an outstanding need to unify business process models, preferably with a high degree of automation.

### SUMMARY OF THE INVENTION

This invention resides in a process for semi-automatic unification of models of business processes permits accurate comparison of business processes across government agencies or other organizations despite heterogeneity of language and style in the original models. Input into an algorithm includes a set of models produced by different organizations that describe roughly equivalent business processes (the original models). Output includes a single integrated model in which similarities are made explicit in shared generic layers of the model, while differences are represented in organization-specific layers that inherit from the generic layers (the unified model). Internally, the system represents the original and unified models in description logic using the Web Ontology Language (OWL).

We make the following assumptions about the original models:
The meaning of the original models must be roughly equivalent. In particular, we assume that they model the same high-level process as implemented in different organizations (e.g., Purchasing).
To provide a starting point, we assume that all of the models share a high-level core ontology for business process modeling. Because this core model is small and has little more content than is implicit in typical process flow diagrams, we do not consider this assumption to significantly limit potential applications of swarming unification.
There are significant differences in the use of terminology, in granularity, and in other aspects of modeling style.

In unified models:
Use of terminology throughout the unified model is consistent and shared
Upper, abstract generic layers represent commonalities between the original models
Lower, organization-specific layers retain the meanings of the original models. Concepts in the lower layers inherit definitional structure from the upper layers.

The unification algorithm has three sub-processes that execute concurrently. These include:
1. Generalization, which matches corresponding elements of the original models to define generic concepts in the unified model.
2. Segmentation, which identifies correspondence in the level of detail across the original models by clustering sub-processes and defining shared, high-level processes.
3. Assimilation/accommodation, which rewrites the original models using unified terminology.

Each of the unification sub-processes is implemented with swarming agents associated with concepts in the original and unified models. For example, in the generalization process there are Pledge Agents associated with concepts in the originals models, and Match Agents associated with shared concepts in the unified model. Match Agents define matches, which can include at most one Pledge Agent from each original model. The Pledge Agents compete with each other to join matches with Pledge Agents associated with similar concepts.

Similarity is estimated as a weighted combination of three methods:
Lexical association, based on co-occurrence of words and/or phrases in a corpus of documents that about business processes. Every concept is represented as a set of words that includes the terms in the name of the concept, and additional words that are associated with the concept by modelers.
Structural association, which is defined by the structure of the original models. Thus, if a matched pair of concepts are each related to concepts that are also matched, then that second match will increase the structural similarity score of the first match.
Suggestions of potential structural association accumulated in the course of the swarming generalization process. These suggestions are represented as digital pheromones: namely, they can propagate over the structure of the ontological models, and they evaporate over time.

The swarming approach has several important advantages for unification of ontological models:
The ability to find near-optimal unifications despite high computational complexity
The ability to gracefully adjust to changes in the problem.
Therefore, the ability to support user interaction that is anytime and anywhere.

Unifying ontologies is a very involved task that can quickly become onerous for users that are primarily interested in their own business processes and not in the complexities of the business processes of other organizations. With swarming unification, however, the system is capable of making progress without any user contribution at all. Users are invited to inject their knowledge when and where they choose. The more insight that users provide, the more rapidly the system will progress: and, typically, the quality of the final output will be higher.

### BRIEF DESCRIPTION OF THE DRAWINGS

FIGS. 1A and 1B illustrate concepts in original models of purchasing for organizations;

FIGS. 2A and 2B illustrate equivalent concepts in unified models for organizations;

FIG. 3 shows a relationship of concept comparison to model unification;

FIG. 4 illustrates a high-level process model for purchasing;

FIG. 5 illustrates musical chairs where pledge agents are the players and match agents are the chairs;

FIG. 6 shows how a good match encourages further corresponding matches;

FIG. 7 is a screen view of the Generalization Overview window running in Protege; and

FIG. 8 illustrates viewing, confirming, and/or modifying matches.

### DETAILED DESCRIPTION OF THE INVENTION

This invention resides in a swarming algorithm that unifies ontological models of business processes in multiple organizations. Unification homogenizes the use of language and modeling style, and improves the integration of the models by increasing the degree to which commonalities are explicit. Unification is valuable because it enables automated comparison of business process models: for example, to analyze process alignment and plan for interoperability. The preferred embodiments take advantage of BPILO, which stands for BUSINESS PROCESS INTEROPERABILITY WITH LIVING ONTOLOGIES, and the swarm intelligence approach to computing.

Model unification is a process that transforms two or more original models into integrated multi-layer unified models. Our focus is on models of business processes, where processes are activities that transform inputs into outputs. We make the following assumptions about the original models that are the input to swarming unification:
The meaning of the original models must be roughly equivalent. In particular, we assume that they model the same high-level process as implemented in different organizations (e.g., Purchasing).
To provide a starting point, we assume that all of the models share a high-level core ontology for business process modeling. Because this core model is small and has little more content than is implicit in typical process flow diagrams, we do not consider this assumption to significantly limit potential applications of swarming unification.
Finally, we assume that the original models exhibit substantial arbitrary heterogeneity on levels that specialize the core model. This heterogeneity will typically include substantial differences in the use of terminology, in granularity, and in other aspects of modeling style.

The models that are the output of swarming unification are very different from the originals. In these unified models:
Use of terminology throughout the unified model is consistent and shared
Upper, abstract generic layers represent commonalities between the original models
Lower, organization-specific layers retain the meanings of the original models. Concepts in the lower layers inherit definitional structure from the upper layers.¹
   ¹ Concepts are defined by their relations to other concepts. Models are thus constituted by a set of overlapping concept definitions.

The process of unification is meant to be semi-automatic. We do not expect the system to be able to automatically generate high quality unified models. We do expect the system to do the bulk of the work towards a unified model. Furthermore, the system should be able to engage users in dialogs that are not onerous for users and that lead to high quality models.

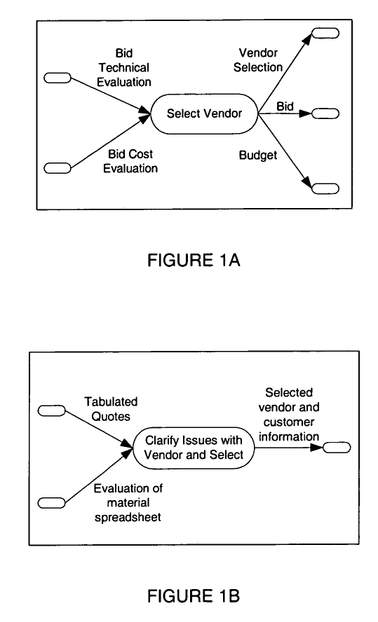

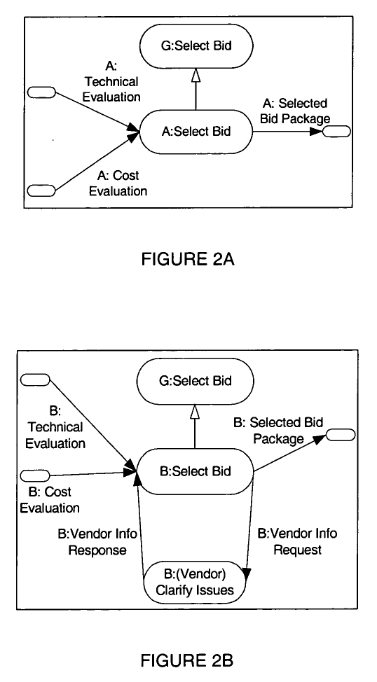

FIG. 1 illustrates extracted fragments of concept definitions that are part of original models of purchasing taken directly from models of purchasing elicited from manufacturers as part of Altarum's work supporting the NIIIP SPARS project. To protect corporate privacy, we talk about Organizations A and B instead of identifying the manufacturers by name. FIG. 2 illustrates equivalent concepts after the original models have been transformed into unified models. In this case, unification was achieved via a knowledge and labor-intensive manual process.

Comparing FIG. 2 to FIG. 1 illustrates the transformations required for unification:
Consistent terminology involving changes to terminology used in both models. For example, “Select Vendor” was changed to “Select Bid” in model A and a similar but somewhat more involved modification was made to model B.
The Select Bid process and also most of the data concepts inherit from generic definitions with the same names (inheritance for the data concepts is not shown in the figures).
There is also some structural transformation of the concepts: in particular, the Clarify Issues with Vendor and Select process has been split into multiple connected concepts.

After unification, isomorphism in the structure of the models for the two organizations that was previously obscured by arbitrary heterogeneity is now clear.

The model unification process can be thought of as a generalization of the concept comparison algorithm that has currently been implemented in BPILO. Concept comparison matches graphs of the concept definitions, finding the one-to-one correspondence that maximizes similarity calculated with relatively simple, local metrics that operate on pairs of individual nodes and edges of the graphs. Thus, model unification and concept comparison both focus on identifying commonality. Concept comparison can contribute directly to model unification as follows: given a one-to-one correspondence, commonality between matched concepts can be separated into relatively abstract generic concepts from which the original concepts inherit.

On the other hand, model unification is a much more ambitious problem than concept comparison with many more degrees of freedom. Concept comparison does not make any changes to the models being compared, while model unification will change the terminology, inheritance structure, and to some degree the compositional granularity of the concepts. Furthermore, while concept comparison is between two concepts, model unification will prefer to operate on sets of analogous models of size greater than two. This is because the larger number of input models will provide a basis for induction of general concepts.

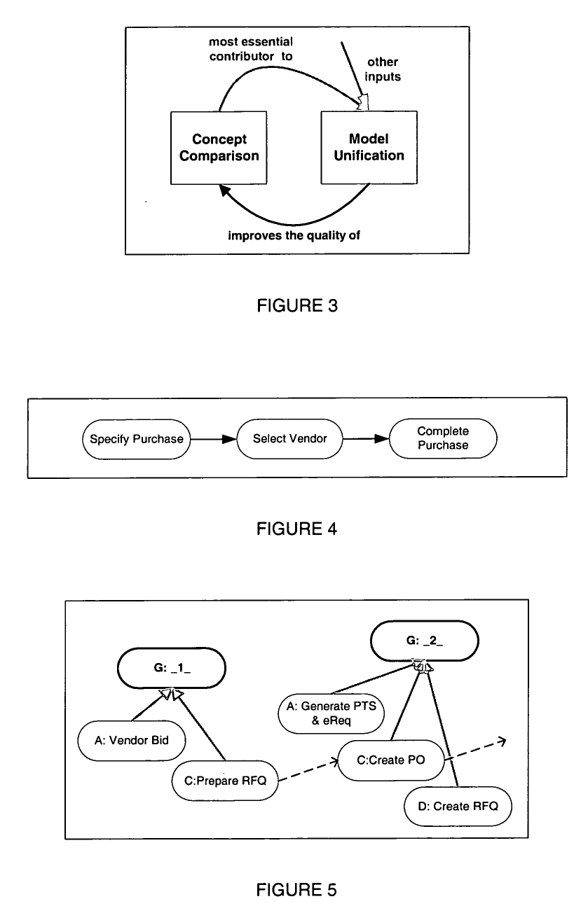

FIG. 3 illustrates the relationship between concept comparison and model unification. Concept comparison will make an essential contribution to model unification, but must be complemented with other inputs. These arrows are gray in the figure because they have yet to be implemented. In return, model unification greatly improves the quality of results from concept comparison. The current concept comparison algorithm does not work well with concepts from original models, because the system does not recognize semantic similarity that is hidden by arbitrary syntactic differences. After (manual) unification to remove arbitrary syntactic differences, concept comparison does work well.

The design unification algorithm applies a very systematic procedure:
We identified commonalities based on our understanding of the meaning of the process and data names. We settled on common names for low-level processes.
We segmented the purchasing processes by identifying a small, high-level process model common to all the original models (see FIG. 4), where each high-level process is composed of sub-processes that are generalizations of concepts in the original models. In other words, we practiced divide-and-conquer, by dividing the original models into smaller pieces that we could more easily compare to each other.
We induced a generic version of each of the high-level processes. This involved examining the segment of each original model describing, for example, how to select a vendor, and including the elements that seemed to be more or less standard, while excluding elements that seemed to be idiosyncratic to a particular organization.
We modified the original models to be as similar in language and structure to the generic version as possible, while retaining the meaning of the original model. We massaged the generic and original models as necessary to permit the organization-specific concepts to inherit from the corresponding generic concepts, while satisfying the strict rules for inheritance in description logic (overrides of inherited values are not allowed).

Another major early design decision will be to use a swarming architecture to implement model unification as a self-organizing, anytime process where local action in a shared environment leads to the emergence of the desired unified models. The important benefits that we believe will follow from using a swarm approach include:
Increased robustness for identifying correspondences that are less than structurally perfect. For example, model A may include two steps in sequence:
   A:C→A:D
   that are semantically similar to concepts C and D in model B, but where B also has an intervening step:
   B:C→B:H→B:D.
   We need to capture this correspondence. Generic graph matching algorithms will, but they tend to be very slow, e.g., with time complexity that is cubic in the size of the graphs being matched. BPILO's current algorithm is much faster, but depends on traversing graph edges to identify candidate matches, thus missing correspondences with intervening steps.
Increased scalability. The unification problem is very difficult and we need an approximate optimization approach to be able to handle large problems. BPLO's current concept comparison algorithm uses best-first search. Best-first search guarantees an optimal solution if there is no pruning of the search space—but pruning is required to handle even moderately sized problems. Thus, best-first search—and other crisp symbolic search procedures—can potentially yield gravely suboptimal results. The swarming approach, in comparison, is stochastic and never guarantees optimal results. On the other hand, it can reliably produce results that are near optimal even for large problems.
Flexible interaction with users. Swarming algorithms are anytime: they produce results that are available immediately, but that improve over time. Furthermore, swarming algorithms tend to be dynamic, adapting gracefully to new inputs. With a swarming implementation, BPILO should be able to support a style of user interaction that is appropriately relaxed, in the sense of benefiting from inputs that the user can provide at any point, while avoiding strict requirements for certain inputs at certain times.

This section describes the preferred swarming unification algorithm. It starts with a high-level architecture, then covers each swarming sub-process including algorithms and user interaction.

The shared processing environment will be a soup of agentized concepts trying to self-organize into coherent unified models. There will be several types of agents, associated with the roles that they will play in the unified models. Each type of agent will focus on one of the following processes, which will execute concurrently:
Generalization (identifying commonality)
Segmentation
Assimilation and accommodation

There will also be system infrastructure that will help agents achieve their goals, monitor the state of the overall system, and interact with users.

Table 1 identifies the types of swarming agents, and sketches how they will be initialized and how they will behave in order to achieve the goal of their process.

TABLE 1
Types of swarming agents

| Agent (Process) | Initial State | Goals | State Changes |
|---|---|---|---|
| Original concept | Mirrors original | Want associations | Add and modify |
| | models | with organization- | associations to |
| | | specific agents that | organization-specific |
| | | represent meaning of | agents. Do not |
| | | original concepts | themselves change, and |
| | | with as much fidelity | do not die. |
| | | as possible. | |
| Organization- | Mirrors original | Strong and balanced | Can spawn clones with |
| specific concept | models, in | associations with | changed name, or that |
| (Assimilation/ | association with | original and generic | divide into multiple |
| Accommodation) | corresponding | concepts (pledges) | concepts. May die |
| | original and generic | | from persistent |
| | concepts | | attenuation of |
| | | | associations. |
| Generic wannabe | Mirrors original | Inclusion in a match. | Musical chairs with |
| concept | models. Heuristic | Maximal lexical | respect to matches. |
| (“pledge”) | assignment to a | association to the | Leave matches to join |
| (Generalization) | generic concept | match. | others; get kicked out |
| The only type of | match. | Maximal matched | of matches when a |
| agent that does | | definitional content. | competing generic |
| not turn into | | | concept from the same |
| concepts in the | | | original model joins. |
| unified model | | | |
| Generic concept | Zero or one pledges | Maximal lexical | Membership changes |
| match (“match”) | from each original | association among | as pledges move about. |
| (Generalization) | model | matched concepts. | Matches move among |
| | | Maximal matched | high-level shared |
| | | definitional content | processes. Role in |
| | | (of all pledges). | high-level shared |
| | | Inclusion in a high- | process changes as |
| | | level shared process | inputs and outputs |
| | | with consistent inputs | clarify and consistency |
| | | and outputs. | is achieved. |
| High-level | Heuristic | Maximal separation | Match membership |
| shared process | assignment of | between segmented | changes as the matches |
| (Segmentation) | initial matches to a | sub-processes. | change and as they |
| | fixed number of | Coherent flows of | move around. |
| | high-level shared | data between match | |
| | processes. May use | sub-processes. | |
| | a priori lists of | | |
| | high-importance | | |
| | documents as | | |
| | boundaries; may | | |
| | also use a priori | | |
| | high level models. | | |

Table 2 identifies elements of the system infrastructure that will be needed to support agents and interaction with users.

TABLE 2
Supporting infrastructure

| | Processes | |
|---|---|---|
| Tool | Supported | Description |
| Agent environment | All | Maintains populations of agents, activating |
| | | them in appropriately randomized ways |
| Semantic lexicon | Generalization | Provides lexical association - estimates of |
| (from research | | topical similarity of words based on co- |
| collaboration with | | occurrence in a corpus of documents about |
| Fair Isaac/HNC) | | business processes |
| WordNet | Generalization, | A full-coverage English ontology with word |
| (available to the | Assimilation/ | specializations and generalizations |
| public on the | Accommodation | |
| internet) | | |
| User dialog | All | Prioritizes questions for users generated by the |
| manager | | swarming processes; maintains answers and |
| | | feeds input into the process |
| Progress monitor | All | Collects metrics on progress towards the |
| | | unified model. Can provide selective pressure |
| | | over alternative swarming configurations. Will |
| | | also guide user interaction. |
| Unified model | All | Resolves inconsistencies in the swarming |
| generator | | environment and generates unified OWL |
| | | models. |
| User interfaces | All | Web or Java application for demonstration |
| | | purposes |

The following sections provide detailed designs for the three unification subprocesses.

The generalization process seeks to identify commonalities among the original models. It is thus the most central of all unification processes. Generalization uses three sources of information:
Lexical association among words in the names of the original concepts or associated with those concepts as metadata. We operationalize lexical association using a third party tool that provides estimates based on the co-occurrence of terms in a corpus of documents that describe the business processes being modeled.
Constraints imposed by the structure of concept definitions. There should be, to the maximal degree possible, one-to-one correspondences between the elements of original concepts that are matched in a shared generic concept. Thus, the generalization process can be viewed as a swarming implementation of graph matching.
Confirmations and suggestions provided by users.

FIG. 5 illustrates “musical chairs” where Pledge Agents (associated with original concepts via organization-specific concepts) jostle with each other to try to end up in a satisfactory match with Pledge Agents representing concepts in other organizations. In the figure, the C: Prepare RFQ Pledge Agent is considering making a request to join the G:_{—}2_ match (G:_{—}2_ will need a real name but let's postpone solving that problem for now). Lexical association make this move seem attractive, partially because of the presence of D:Create RFQ in G:_{—}2_ and partly because of association between “prepare”, “generate”, and “create”. When C:Prepare RFQ does make the request to move, G:_{—}2_ has a chance to reject the request. Only one concept from each organization can be included in the match, so accepting C:Prepare RFQ will cause C:Create PO to be excluded. When this happens, C:Create PO is given the next chance to move to find a new match.

The generalization process will utilize the structure of concept definitions in two related ways:
For generating candidate destinations for Pledge Agent moves
For contributing to estimates of the degree to which Pledge Agents belong in a match. Pledges will be happiest when in a match such that concepts to which it is linked in its original model are also matched to corresponding concepts from other original models. This should yield a crystallization effect, where matches that start to come together well cause a cascade of other matches to form into a configuration. Hopefully, the resulting stable configurations will also be near optimal. To achieve this result may require controlling the temperatures of the agents' stochastic decisions as in simulated annealing, and so on.

As in many swarming algorithms, we will use digital pheromones to aggregate and smooth suggestions for matching. In this case, the Match Agents will be the depositors of pheromones, and the Pledge Agents themselves will represent the structure of the original models and will be the environment in which pheromones are deposited.

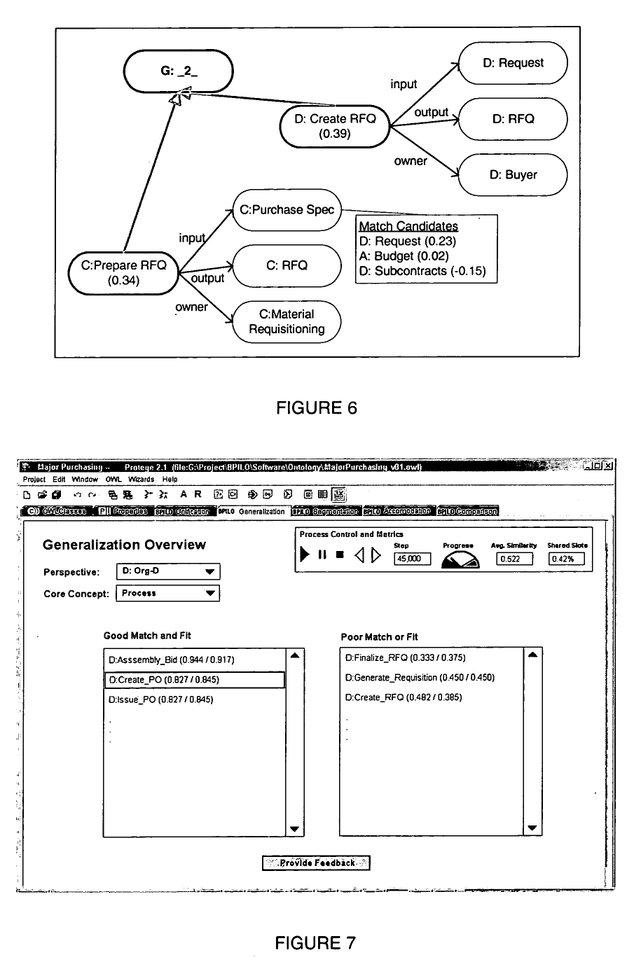

FIG. 6 shows the match of C:Prepare RFQ and D:Create R in G:_{—}2_, and also concepts that are linked to these concepts in the original models. The match of these concepts has two effects (in the figure, the matched concepts and the effects of the match are highlighted in red). First, it encourages concepts such as C:Purchase Spec, which are linked to C:Prepare RFQ in the organization C model, to match to corresponding concepts such as D:Request. The next time C:Purchase Spec gets a chance to move, the chances are good that it will pick the match of D:Request as a destination (everything in swarming algorithms is done stochastically to avoid premature convergence to local optima). The amount of pheromone deposited to encourage matching to D:Request will depend on the estimated quality of the match in G:_{—}2_. Furthermore, because a match with D:Request is incompatible with a match with D:Subcontracts, negative pheromone may be deposited on that concept.

Secondly, the presence of pheromone in linked concepts will contribute to estimates of the quality of a match. In FIG. 6, for example, say that C:RFQ and D:RFQ are already in the same match. The that match will increase the estimated quality of the match in G:_{—}2_, causing increased deposit of pheromone by that match. In this manner, pheromone will propagate through the structure of the original models. We may also experiment with a direct form of propagation, where match candidates spread pheromone to further candidate matches as if the initial candidates were matched (but with progressively attenuated strength). Furthermore, pheromones will evaporate as is typical in swarming algorithms to give the system the flexibility to forget old, probably sub-optimal solutions.

Unifying ontologies is a very involved task that can quickly become onerous for users that are primarily interested in their own business processes and not in the complexities of the business processes of other organizations. Therefore, we need to avoid asking too much of users, who will reject a system that requires them to make numerous difficult decisions about things that they do not care very much about.

Therefore, user interaction with swarming unification is designed to be anytime and anywhere. The system will be capable of making progress—to some degree—without any user contribution at all. Users will be invited, however, to inject their knowledge when and where they choose. The more insight that users provide, the more rapidly the system will progress: and, perhaps, the quality of the final output will tend to be higher.

FIG. 7 shows an illustration of a window that provides an overview into the progress of the generalization process. BPELO is currently implemented as extensions to the Protege Ontology Editor <refs>. FIG. 7 shows tabs for windows in Protege that provide, respectively, an overview of model unification in its entirety, an overview of each of the unification subprocesses, and an entry point into the comparison and analysis of models.

In the Generalization Overview window, the user identifies her perspective (typically either her organization, or a non-organization-specific generic perspective), and the core concept that she would like to focus on (for example, processes, data items, organizational units, and so on). The system then lists all of the elements that specialize the core concept in the selected organization's original models, sorted in two ways: highlighting those cases in which the system is doing well, and highlighting cases where the system is doing poorly (which may be the result of either genuine or arbitrary heterogeneity). Each list is sorted by the similarity of the match, which is the average of all pairwise comparisons of concepts in the match. The fit of the concept in the match is also shown: this is the average of the pairwise comparisons between the selected concept and others in the match.

The Process Control and Metrics tool bar in the upper right of the window will be included in every window for swarming unification. The familiar control symbols on the left of the toolbar include Play, Pause, Stop, where playing means carrying on with the unification processes. The Back and Forward buttons are relevant for navigational decisions, and for changes to system state (in this respect the buttons are equivalent to Undo and Redo). The Step metric shows how long the process has been underway, the Progress gauge is a meta-metric that summarizes that quality of unification achieved so far, and the Average Similarity and Shared Slots metrics are key metrics for generalization. Average Similarity is the average similarity of all matches produced, with weighted contributions from similarity metrics that include lexical associations and structural correspondence. The Shared Slots (a.k.a. Properties) metric shows the number of relations attached to generic concepts that can be abstracted from the current set of matches.

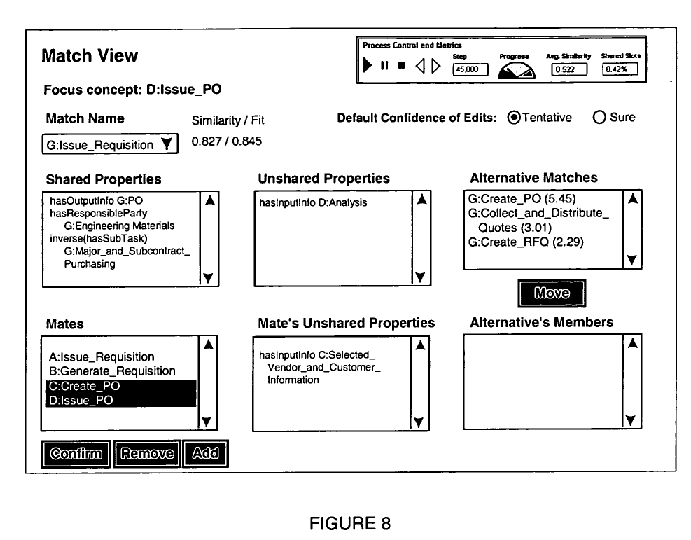

Selecting a concept in FIG. 7 and hitting the Provide Feedback button launches the Match View window shown in FIG. 8. This window has three columns of lists. The leftmost column describes the match, which embodies the similarities found among the match's member concepts. The middle column shows elements of the member concepts that are not included in the match: hence, the focus is on differences. The rightmost column shows other matches that the selected concept might potentially be part of.

In many of the lists in the Match View window, single-click selection of an item causes other lists to update to be consistent with the selection. For example, selecting a concept in the Mates list causes the Mate's Unshared list to update. Double-click selection of an item causes the system to navigate the focus to the match of the selected concept. For example, double-clicking on A:Issue_Requisition in the Mates list will cause that concept to be the focus concept, effectively redisplaying the entire window. (Users are always free to navigate back to their previous state with the Back button in the control toolbar).

The buttons, meanwhile, provide the means for users to actively modify the generalization process. In FIG. 8, for example, the user has selected two concepts in the Mates list in preparation for Confirming that these items belong together. Selected concepts can also be removed from the match; and it is also possible to select any concept for inclusion in the match. Finally, users can select a match from the Alternative Matches list and move the focus concept to that match. Concepts in the Alternative Matches list are sorted according to their current level of digital pheromones, which is the system's way of accumulating suggestions.

Any user contributions can be asserted with varying levels of certainty. To keep things simple for users, we may restrict choices about certainty to “tentative” and “sure”. The system will enforce and permanently remember assertions that are said to be sure. In some cases, the system may need to ask for further input from users to clarify their intentions. For example, when moving a concept into a new match, the user may or may not intend to confirm that all of the new match's concepts definitely belong together. Tentative assertions will be immediately implemented but the system may forget them over time if the dynamics of the process lead away from the suggested state.

Whenever the user makes a change to the state of the generalization process, the system will automatically press the Pause button to give the user a chance to assess the impact of the change. Generally, users will keep their eyes on the metrics in the control toolbar. If a change as an unanticipated and negative effect, users may press the Back button to undo their contribution.

We claim:

1. A business model unification process, comprising the steps of:
inputting a set of original models produced by different organizations that describe roughly equivalent business processes; and
operating upon the original models with an algorithm to output a unified model in which similarities are made explicit in shared generic layers of the model, while differences are represented in organization-specific layers that inherit from the generic layers.

2. The method of claim 1, wherein the original models involve substantially the same high-level process as implemented in the different organizations.

3. The method of claim 1, wherein the original models share a high-level core ontology for business process modeling.

4. The method of claim 1, wherein the use of terminology throughout the unified model is consistent and shared.

5. The method of claim 1, wherein the unified model includes upper, abstract generic layers that represent commonalities between the original models.

6. The method of claim 1, wherein the unified model includes lower, organization-specific layers that retain the meanings of the original models.

7. The method of claim 1, wherein the unified model includes upper, abstract generic layers and lower, organization-specific layers; and
wherein concepts in the lower layers inherit definitional structure from the upper layers.

8. The method of claim 1, wherein the algorithm includes a generalization sub-process which matches corresponding elements of the original models to define generic concepts in the unified model.

9. The method of claim 1, wherein the algorithm includes Pledge Agents associated with concepts in the originals models, and Match Agents associated with shared concepts in the unified model; and wherein:
the Match Agents define matches, which can include at most one Pledge Agent from each original model, and
the Pledge Agents compete with each other to join matches with Pledge Agents associated with similar concepts.

10. The method of claim 1, wherein the algorithm includes a segmentation sub-process which identifies correspondence in the level of detail across the original models by clustering sub-processes and defining shared, high-level processes.

11. The method of claim 1, wherein the algorithm includes an assimilation/accommodation sub-process which rewrites the original models using unified terminology.

12. The method of claim 1, wherein at least a portion of the algorithm is implemented with swarming agents associated with concepts in the original and unified models.

13. The method of claim 1, wherein similarity is estimated as a weighted combination of multiple methods.

14. The method of claim 13, wherein one of the methods is lexical association.

15. The method of claim 1, wherein one of the methods is structural association.

16. The method of claim 1, wherein one of the methods is based upon suggestions of potential structural association accumulated in the course of a swarming generalization process.

17. The method of claim 1, including models described using a Web Ontology Language.
